(19) United States
(12) Patent Application Publication
(10) Pub. No.: US 2005/0128284 A1
(43) Pub. Date: Jun. 16, 2005

(54) Video conference system with a camera disposed in a computer

(76) Inventors: Cary J. Hoffer, Albany, OR (US); Memphis-Zhihong Yin, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/733,033

(22) Filed: Dec. 11, 2003

(51) Int. Cl. H04N 7/14

(52) U.S. Cl. 348/14.02; 348/14.04

(57) ABSTRACT

A video conference system has a computer and a camera. The camera is disposed in the computer in a first position and is mechanically detached from and electrically coupled to the computer in a second position.

### BACKGROUND

During a video conference, a camera can be connected to a computer to provide a video and audio interface to a remote location. For example, if participants at two different locations have a camera and computer, a video and audio link can be established so the parties can communicate.

The camera and the computer may be sold separately and later connected to establish the video link for the video conference. The camera, for example, may include a base or mount for holding the camera. A connector, such as a universal serial bus (USB) cable, can be connected between the camera and computer for establishing a communication link between these two devices.

Portable video conferencing can be utilized if the computer is portable, such as a laptop or notebook computer. A camera associated with a laptop, for example, can enable portable multimedia systems that are capable of video conferencing. Improvements in portable and non-portable multi-media systems are desired.

### SUMMARY

In one embodiment, a portable computer comprises a base portion with a keyboard and an electronic display connected to the base portion. A camera is stored in the base portion, wherein the camera automatically powers on when ejected from the base portion.

In another embodiment, a method comprises automatically powering a camera on while ejecting the camera from a computer; and automatically powering the camera off while inserting the camera into the computer.

In yet another embodiment, a video conference system comprises a computer and a camera. The camera is movable between a first position and a second position, wherein the camera is disposed in the computer in the first position and is mechanically detached from the computer in the second position. The camera is electrically coupled to the computer in the second position.

Other embodiments and variations of these embodiments are shown and taught in the accompanying drawings and detailed description.

### BRIEF DESCRIPTION OF THE DRAWINGS

FIG. 1 is a perspective view of a portable electronic device with a camera according to an exemplary embodiment of the invention.

FIG. 2 is a perspective view of the portable electronic device of FIG. 1 with the camera ejected from the portable electronic device.

FIG. 3 is a close-up perspective view of the portable electronic device and camera illustrating rotation of the camera about a first axis.

FIG. 4 is close-up perspective view of the portable electronic device and camera illustrating rotation of the camera about a second axis.

FIG. 5 is a perspective view of the portable electronic device with the camera directed to one of two viewers.

FIG. 6 is a perspective view of the portable electronic device with the camera directed to another one of two viewers.

FIG. 7 is a perspective view of the camera mechanically detached from the portable electronic device.

### DETAILED DESCRIPTION

FIG. 1 shows a portable computing or electronic device 100 according to an exemplary embodiment of the invention. For convenience of illustration, the portable electronic device 100 is illustrated as a laptop or notebook computer. Embodiments in accordance with the present invention, though, are not limited to laptop or notebook computers. By way of example, embodiments in accordance with the present invention include, but are not limited to, computers (portable and non-portable), laptops, notebooks, personal digital assistants (PDAs), tablet PCs, handheld and palm top electronic devices, compact disc players, portable digital video disk players, radios, cellular communication devices (such as cellular telephones), and other electronic devices and systems whether such devices and systems are portable or non-portable.

FIG. 1 shows portable electronic device 100 as a notebook or laptop computer. Portable electronic device 100 includes display portion 102 hinged to a base portion or case 104. Base portion 104 has a top portion 106, bottom portion 108, and four sides designated as front side 112, back side 114, left side 116 and right side 118.

The base portion 104 has a generally rectangular or square body and may be configured in many different ways, such as different sizes and shapes. Further, the base portion 104 may comprise and house a variety of different electronic components. By way of example only, the base can house and comprise a central processing unit (CPU), hard drive, memory, infrared ports, disk drives, PC card slots, batteries, USB ports, power connectors, monitor and display connectors, multibays, network connectors, CompactFlash card slots, power connectors, and other input/output (I/O) ports, just to name a few examples.

The top portion 106 of base portion 104 also includes a touch-pad 120 and a keyboard 122 with a plurality of keys. The keyboard 122 can function as a traditional “QWERTY” alphanumeric keypad or a traditional numeric keypad. In alternate embodiments, the keyboard 122 comprises a flexible membrane keyboard having touch sensitive or pressure sensitive key areas on a planar surface. The keyboard could comprise opposed flexible plastic or polymeric membranes that house pressure sensitive switches identifiable with particular letters, numbers, symbols, and functions for inputting data into the computing device. Further yet, the keyboard 122 does not have to comprise a flexible membrane configuration or have any particular embodiment. The keyboard, for example, could have a hard plastic outer shell. Pressure or touch sensitive key areas could be disposed along an inner side of this shell.

The display portion 102 generally comprises a view screen or panel 130 on a front surface. The screen 130 may be a touch sensitive screen that both displays data and inputs data when touched or activated. In other embodiments, the screen may only be capable of displaying information. In such embodiments, information can be input via a keyboard, a mouse, voice activation, or other means. By way of example, screen 130 may be a backlit color liquid crystal display (LCD). Data may be entered through the screen using, for example, a stylus or a user's finger. Images that appear on the screen provide a graphical user interface (GUI) and may be controlled with software (including handwriting recognition software) such that displayed images may be contacted or activated to input, edit, alter, or otherwise access information. When a user touches or activates a designated area on the screen, for example, the touch sensitive screen transmits a signal to the CPU.

As shown in FIG. 1, the display portion 102 is mechanically coupled to the base portion 104 with a hinge assembly 140. The hinge assembly 140 enables the display portion 102 to pivotally move between an open position and a closed position.

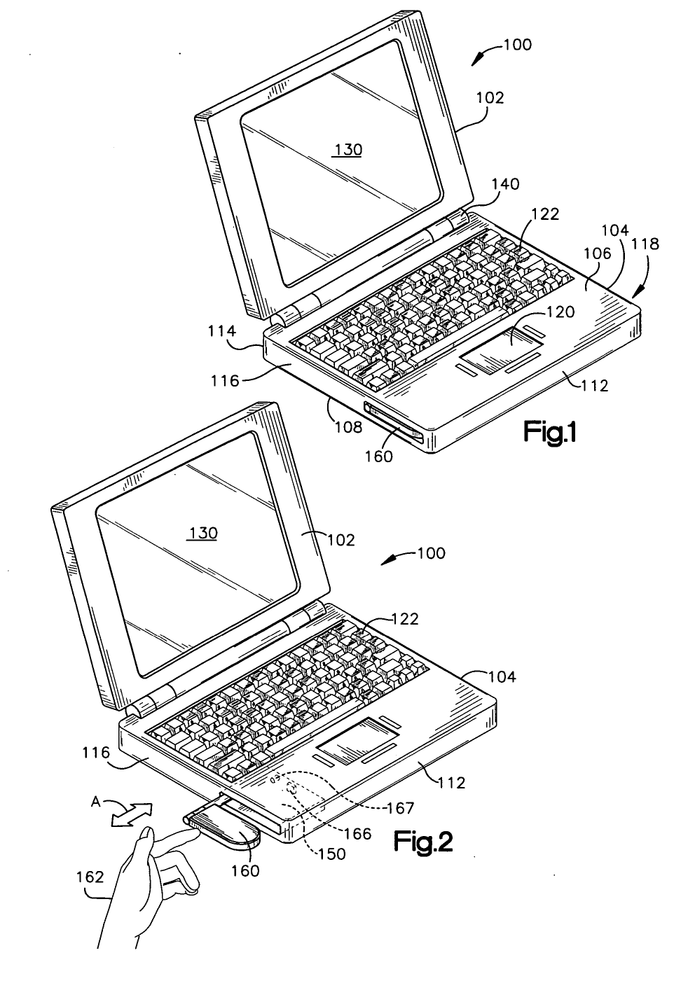

As best shown in FIG. 2, the base portion 104 includes a cavity, opening, or recess 150 (shown in phantom) accessible from side 116. The cavity 150 is shaped and sized to house a camera or camera assembly 160.

In one exemplary embodiment, the camera 160 is integrally formed to or permanently attached to the portable electronic device 100. The camera is movable from a first position or storage position received within the cavity 150 of base portion 104 (as shown in FIG. 1) to a second position or ejected position (as shown in FIG. 2). The camera can move between the stored and ejected positions shown along arrow “A” by actuation of a user 162.

A locking mechanism 166 is disposed within cavity 150. The locking mechanism can be actuated to lock the camera in the cavity 150 or remove or eject the camera. In the storage position (as shown in FIG. 1), the locking mechanism 166 securely retains the camera 160 in cavity 150. When user 162 pushes on the housing of the camera 160, the locking mechanism disengages, and the camera ejects from the base portion 104. Various mechanical mechanisms can be used as a locking mechanism. For example, a spring and latch, disposed within the cavity 150, can be adapted to engage the camera or camera assembly for holding and releasing the camera. When the camera 160 is pushed into the base portion 104, the latch disengages and the spring biases the camera out of cavity 150.

Preferably, the camera is in a power-off mode while positioned in the cavity 150 in the storage position. Once the camera moves from the storage position to the ejected position, the camera automatically actuates to a power-on mode. In this regard, an electronic switch 167 can be provided in the cavity 150. When the camera is ejected, the switch 167 can activate the camera to power-on. Further, when the camera is positioned into the storage position, the switch 167 can activate the camera to power-off. When the camera 160 is pushed into the base portion 104, the switch 167 automatically activates the camera into the power-off mode (i.e., shuts the camera off). When the camera is pushed and ejected out of the base portion 104, the switch 167 automatically activates the camera into the power-on mode (i.e., turns the camera on). Thus, a separate on/off switch on the camera or on the portable electronic device 100, for example, does not have to be manually activated by a user to turn power the camera “on” and “off.”

A variety of switches or switch technologies can be used to automatically power the camera on when it is ejected and automatically power the camera off when it is stored. By way of example only, the switch 167 could be provided as a magnetically actuated electrical switch, a microswitch, a pressure switch, or a push-button type switch activated when the camera is moved.

As best shown in FIG. 1, when the camera 160 is in the storage position, the outer surface or housing of the camera is flush with the side 116 of the base portion 104. In this position, the exterior surface of the camera provides a protective cover for the camera and, simultaneously, forms part of the side 116. Preferably, the lens of the camera is not exposed along the side 116 while the camera is in the storage position.

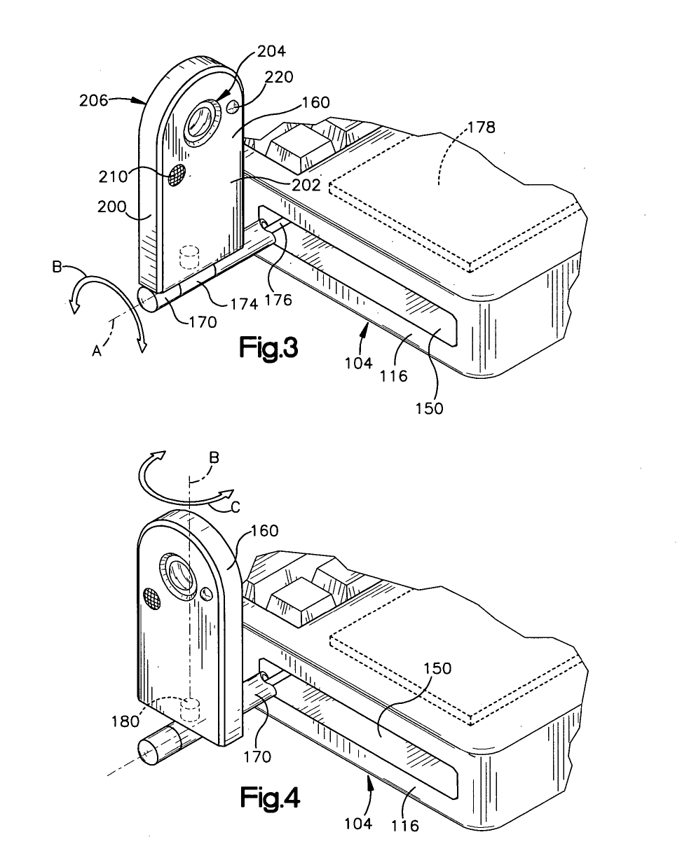

As shown in FIG. 3, the camera 160 includes a housing 200 having a front face 202 with lens assembly 204 disposed on the front face. The lens assembly 204 is positioned near a top portion 206 of the housing 200 such that the lens points out and away from the front face 202. The viewing direction of the lens, for example, can be directed perpendicularly away from the front face 202 of the housing 200.

A microphone or audio detector 210 is positioned on the front face 202 of the housing 200. Further, a light 220, such as a light emitting diode (LED), can be positioned on the front face 202. The light 220 can be activated or illuminated to indicate that the camera is on and video and/or audio recording or transmission is occurring.

The camera 160 can include various functions or features now known or developed in the future. By way of example only, the camera can comprise an adjustable focus, an on/off switch, a menu display, and/or functional controls for adjusting the mode of operation, to name only a few examples.

As illustrated in FIG. 3, the camera 160 is permanently attached to an adjustable mounting member 170. The mounting member has an elongated cylindrical or tube shape. A first hinge or pivot assembly 174 is provided on the mounting member 170. The first hinge assembly 174 enables the camera to rotate about a first axis “A” shown along arrow “B.” Preferably, the camera 160 can rotate a full 360° about axis “A.”

The mounting member 170 may be hollow or otherwise adapted to carry or house a conduit 176 for electrically coupling the camera 160 to the portable electronic device 100. For example, the conduit 176 can electrically couple the camera to a circuit board 178, power supply, processor, and/or other electronic components housed within the base portion 104. Further, the conduit 176 can be electrically coupled to the switch 167 (shown in FIG. 2) so the camera automatically turns on when moved to the ejected position and automatically turns off when moved to the storage position.

As best shown in FIG. 4, a second hinge or pivot assembly 180 is provided on the mounting member 170. The second hinge assembly 180 enables the camera to rotate about a second axis “B” shown along arrow “C.” Preferably, the camera 160 can rotate a full 360° about axis “C.”

As shown in FIGS. 3 and 4, the camera 160 can fully rotate or adjust about two different axes. Rotation can occur along a single axis, or the rotation can simultaneously occur along both axes. The camera is thus able to accommodate a plurality of different viewing angles for the lens assembly 204. In order to move or adjust the position of the camera, a user can manually move or rotate the camera about axes “A” and “B.”

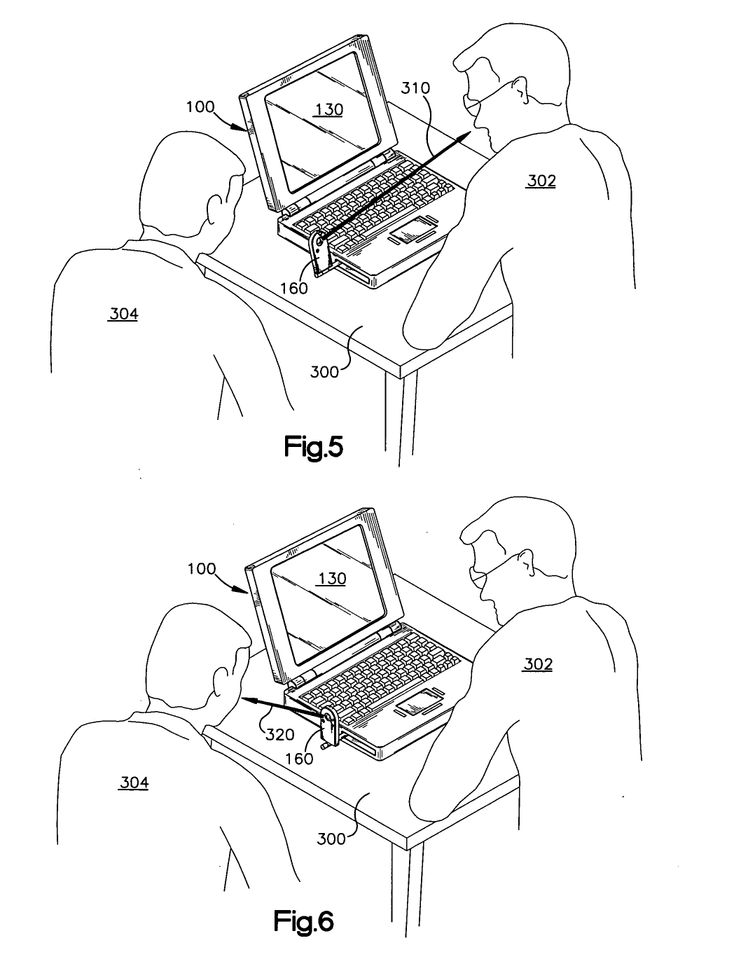

FIGS. 5 and 6 show two possible viewing scenarios to illustrate the adjustability of the camera 160. In FIG. 5, the portable electronic device 100 is situated on a table 300 with a first user or participant 302 situated in front of the screen 130 while a second user or participant 304 is situated to the side of the screen 130. The camera 160 is rotated slightly counterclockwise about axis “A” (FIG. 3) so the viewing angle 310 of the camera is directed to the first user 302.

In FIG. 6, the portable electronic device 100 is situated on the table 300 with the first user 302 situated in front of the screen 130 while the second user 304 is situated to the side of the screen 130. The camera 160 is rotated about axis “B” (FIG. 4) so the viewing angle 320 of the camera is directed to the second user 304.

In the exemplary embodiments discussed in connection with FIGS. 1-6, the camera 160 is permanently attached to the portable electronic device 100. Other embodiments are also within the scope of the invention. The camera could be removable from the portable electronic device. For example, once the camera is ejected from the cavity 150, the camera could be detached from mounting member 170 and moved or positioned to a variety of locations without being restrained to rotation or movement about two different axes. The camera could then be re-attached to the mounting member and inserted back into the storage position in cavity 150.

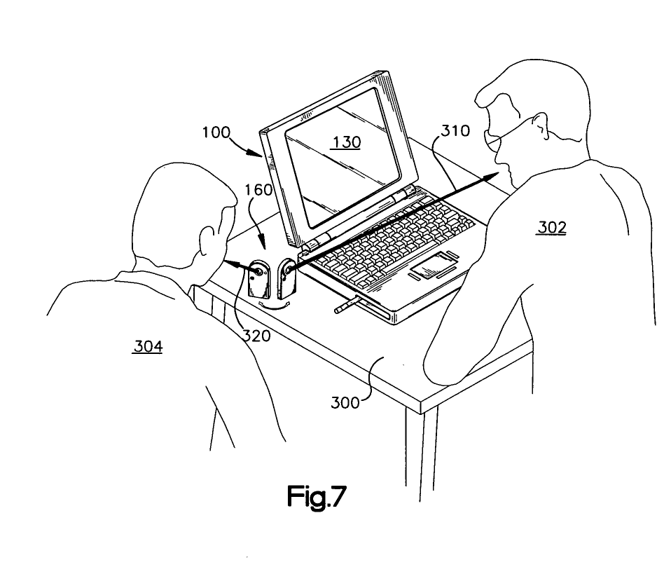

Looking to FIG. 7, the camera 160 is unattached from the mounting member 170 (see FIG. 3) and can freely move in any direction. For convenience of illustration, the camera 160 is placed on table 300. In this position, for example, the camera 160 could be situated so the viewing angle 310 is directed to the first user 302. Alternatively, the camera could be situated so the viewing angle 320 is directed to the second user 304.

As shown in FIG. 7, the camera 160 is mechanically unattached to the portable electronic device 100. At the same time, however, the camera call be in electrical communication with the portable electronic device. A variety of wireless technologies can be used to establish signal communication between the camera and portable electronic device. For example, radio frequency (RF) can be used. The camera can include an RF antenna or transmitter. When an RF current is supplied to the antenna, an electromagnetic field is created that propagates through space to a corresponding RF receiver located in the portable electronic device. As one specific illustration, Bluetooth® wireless technology can be used to establish a wireless link between the camera and the portable electronic device.

Further, the camera 160 can include a rechargeable power supply to power the camera while it is physically removed or unattached from the portable electronic device 100. Various rechargeable power supplies and batteries are known in the art and can be utilized with embodiments in accordance with the present invention. Looking to FIG. 3, for example, the rechargeable power supply can be located in the housing 200 and electrically coupled to the portable electronic device via conduit 176. When the camera is attached to the mounting member 170, the rechargeable power supply can be recharged. Recharging could occur, for example, if the camera were removed from the portable electronic device (as shown in FIG. 7) and subsequently re-attached to the mounting member 170.

In one exemplary embodiment, the camera 160 and the portable electronic device 100 comprise a multi-media system. The multi-media system is adapted, for example, to perform video conferencing. The camera, though, is not limited to a video camera or a camera adapted for use with video conferencing or multi-media presentations. The camera, for example, can be a digital camera for taking still digital photographs and/or digital video.

While the invention has been disclosed with respect to a limited number of embodiments, those skilled in the art will appreciate, upon reading this disclosure, numerous modifications and variations. It is intended that the appended claims cover such modifications and variations and fall within the true spirit and scope of the invention.

1) A portable computer, comprising:
a base portion with a keyboard;
an electronic display connected to the base portion; and
a camera stored in the base portion, wherein the camera automatically powers on when ejected from the base portion.

2) The portable computer of claim 1 wherein the camera automatically powers off when inserted into the base portion.

3) The portable computer of claim 1 further comprising an elongated mounting member connected to the camera.

4) The portable computer of claim 3 wherein the mounting member has a cylindrical shape and provides electrical communication between the camera and the base portion.

5) The portable computer of claim 1 further comprising a mounting member that mechanically and electrically couples the camera to the base portion.

6) The portable computer of claim 5, wherein one end of the camera is connected to the mounting member, the camera being movable about two different axes while connected to the mounting member.

7) The portable computer of claim 1 wherein the base portion comprises a cavity, and the camera is stored inside the cavity.

8) The portable computer of claim 7 wherein the cavity is formed in a side of the base portion.

9) The portable computer of claim 1 wherein:
the camera is movable between a storage position disposed inside the base portion and an ejected position disposed outside of the base portion, the camera being mechanically connected to the portable computer while in the ejected position; and
the camera is movable about two different axes while in the ejected position.

10) A method, comprising:
automatically powering a camera on while ejecting the camera from a computer; and
automatically powering the camera off while inserting the camera into the computer.

11) The method of claim 9 further comprising activating a switch located inside the computer while ejecting the camera from the computer to perform said automatically powering the camera on.

12) The method of claim 11 further comprising activating the switch located inside the computer while inserting the camera into the computer to perform said automatically powering the camera off.

13) The method of claim 9 further comprising inserting said camera into a cavity in the computer so an outer surface of the camera forms an exterior surface of the computer.

14) The method of claim 9 further comprising removing the camera from mechanical attachment to the computer, and transmitting a wireless signal from the camera to the computer.

15) A video conference system, comprising:
a computer; and
a camera movable between a first position and a second position, wherein the camera is disposed in the computer in the first position and is mechanically detached from the computer in the second position, the camera being electrically coupled to the computer in the second position.

16) The video conference system of claim 15 wherein the camera has a housing that is completely disposed inside a cavity in the computer in the first position such that the housing forms an exterior surface of the computer.

17) The video conference system of claim 15 wherein the camera transmits wireless signals to the computer while in the second position.

18) The video conference system of claim 15 wherein the computer further comprises a mounting member, wherein the mounting member is disposed inside the computer in the first position and extends outwardly from the computer in the second position.

19) The video conference system of claim 18 wherein the camera is mechanically connected to the mounting member while in the first position.

20) The video conference system of claim 15 wherein the camera is in a power-off state while in the first position and automatically transitions to a power-on state when the camera physically moves from the first position to the second position.
